(19) United States
(12) Patent Application Publication
(10) Pub. No.: US 2005/0172428 A1
(43) Pub. Date: Aug. 11, 2005

(54) Device in a circular, disk-shaped element intended for cleaning purposes

(76) Inventor: Hakan Thysell, Soderkoping (SE)

Correspondence Address: HARNESS, DICKEY & PIERCE, P.L.C., P.O. BOX 8910, RESTON, VA, 20195, US

(21) Appl. No.: 10/506,026

(22) PCT Filed: Feb. 26, 2003
(86) PCT No.: PCT/SE03/00310

(30) Foreign Application Priority Data
Mar. 13, 2002 (SE) 0200754-0

(51) Int. Cl. B60S 3/00

(52) U.S. Cl. 15/4; 15/180; 15/230; 451/350; 451/526

(57) ABSTRACT

The invention relates to a device in a circular disk-shaped cleaning element intended for cleaning by means of a cleaning machine. The element is designed with a number of recesses (3) distributed over the active cleaning surface (2a) thereof. Grinding elements (4)containing industrial diamonds and conventionally used for grinding stone and concrete floors are arranged in the said recesses. The grinding elements are fixed in such a way that in use they only come into light contact with the surface that is to be cleaned. The invention further relates to the use of a cleaning element in connection with wet cleaning conventionally performed with a cleaning machine. Alternatively the device may be used in such a way that dry polishing is first performed using the cleaning element, following which wet cleaning is carried out using a conventional cleaning element.

The present invention relates to a device according to the pre-characterizing clause of claim 1.

In professional floor cleaning, for example in department stores, cleaning machines are used in attempts to remove dirt mechanically, often with the addition of chemicals. As the floors become ever more worn that is to say scored and cracked and, particularly in the vicinity of dairy and meat counters, exposed to chemical wear, the cleaning results increasingly deteriorate, and attempts have been made to remedy this with ever greater quantities of more powerfully acting chemicals. It might be said that, in this way, cleaning ends up in vicious circle.

Although it is true that this vicious circle can be broken by grinding the floor, thereby removing the scores and cracks in which dirt collects, such grinding requires special machines, takes a relatively long time to carry out and is also relatively costly.

U.S. Pat. No. 5,054,245 A, U.S. Pat. No. 5,605,493 A and U.S. Pat. No. 6,234,886 B1 are cited as examples of the prior art. These published patents relate to devices of the type specified in the pre-characterising clause of claim 1, and mole specifically to cleaning machines in which, in order to achieve a better cleaning result, the ordinary cleaning elements of the machine are combined with grinding elements containing grinding material such as diamond for grinding stone floors, for example.

The object of the present invention is to provide a device of the aforementioned type, by means of which cleaning can be rendered more efficient and the time interval between two grinding operations can be considerably extended. This is achieved in that the invention has the features specified in the characterising part of claim 1.

The sub-ordinate claims 2-3 specify advantageous embodiments of the invention.

The invention also relates to the use of a cleaning element according to the invention as set forth in claim 4.

The invention will be explained in more detail below with reference to the drawing attached, in which

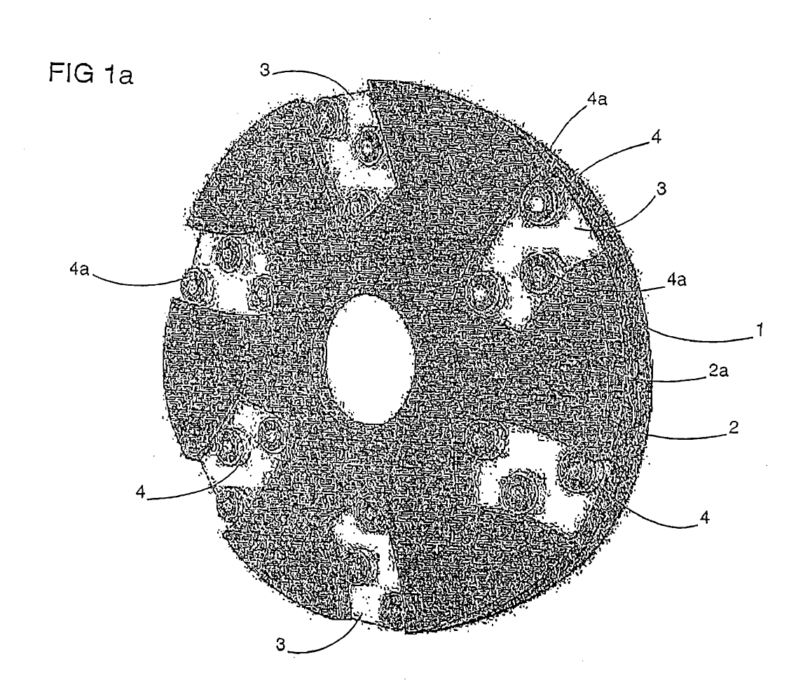

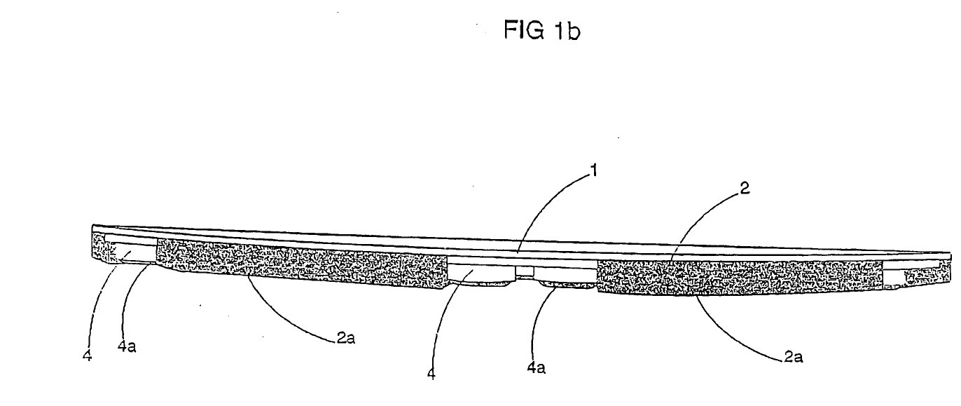

FIG. 1a, in a perspective view shows, by way of example, a cleaning element with a nylon scouring surface according to the invention.

FIG. 1b shows a cross-section through the cleaning element in FIG. 1a.

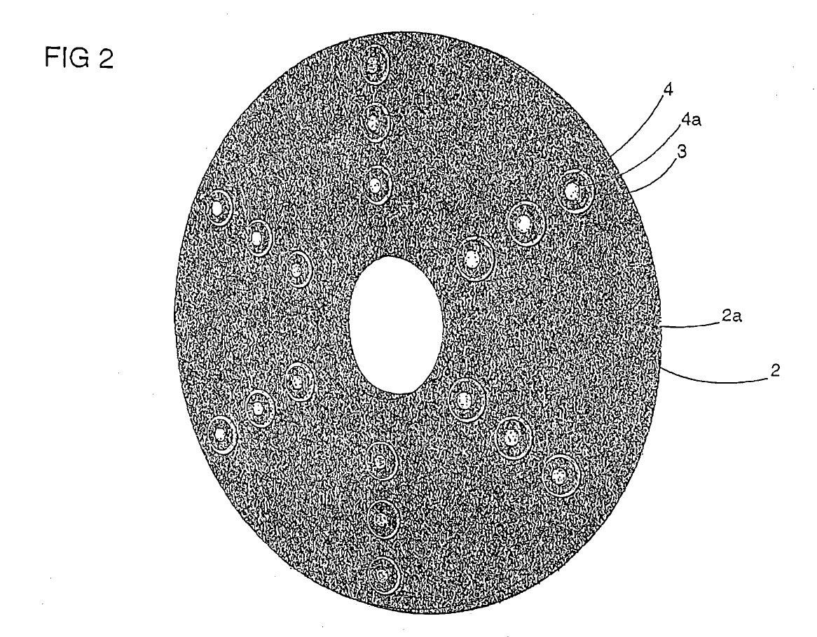

FIG. 2a in a perspective view shows another example of an embodiment with a brush surface and in which grinding elements are arranged in a different pattern to that in FIG. 1a.

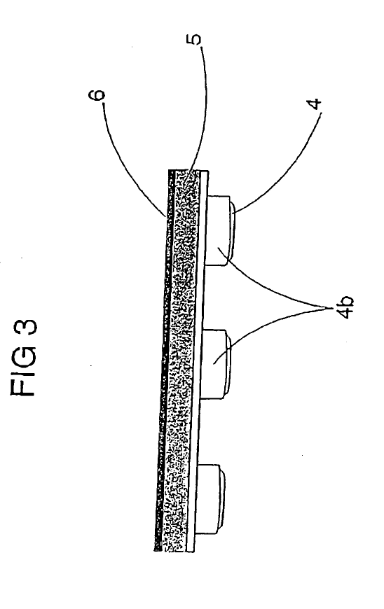

FIG. 3 shows a cross-section through a grinding element in a spring-mounted thermoplastic holder.

Fitted to a cleaning machine of conventional type, a circular, disk-shaped cleaning element according to the invention is intended to improve the cleaning result and to this end comprises a rigid bottom disk 1, which is slightly convex. Fixed to the bottom disk 1 is a disk 2 made from a material which from experience gives a good cleaning result. Such a material is, for example, so-called nylon scouring material. In the disk 2 are a number of recesses 3 distributed over the active cleaning surface 2a thereof. Grinding elements 4 are arranged in the said recesses in such a way that, in the cleaning operation, these only come into light contact with the surface that is to be cleaned. The grinding elements 4, which are arranged in various patterns, and at the corners of a triangle in the embodiment shown in FIG. 1a, are of the usual type used in grinding stone or concrete floors and contain industrial diamonds. The requirement that the grinding element should only come into light contact with the surface that is to be cleaned is met in that when the disk 2 is compressed in use the active surface 4a of the elements lies directly under the active surface 2a of the disk 2.

As shown in FIG. 3, each grinding element 4 is enclosed in a thermoplastic holder 4b and the holder is in turn spring-mounted on the bottom disk 1 of the cleaning element. The springing preferably consists of a siliconc spring disk 5 and is fixed to the bottom disk 1 by means of a Velcro element 6.

As will be apparent from another particular characteristic of the invention and as is shown in FIG. 2, the cleaning element is designed with a bush surface, that is to say the disk 2 is of a bush-like material. It will be appreciated that the disk 2 may naturally be designed with a combination of nylon scouring material and brush-like material. In the embodiment shown in FIG. 2 the grinding elements are located in radial rows, a recess being provided for each grinding element.

The device may alternatively be used in such a way that dry polishing is first performed using the cleaning element according to the invention, following which wet cleaning is carried out using a conventional cleaning element such as a nylon scouring disk.

1. device in a circular disk-shaped cleaning element, which is intended for cleaning by means of a cleaning machine and is designed with a number of recesses distributed over the active cleaning surface thereof, in which recesses grinding elements, containing industrial diamonds and conventionally used for grinding stone and concrete floors, are arranged so that when the disk x is compressed the grinding elements are brought into light contact with the surface that is to be cleaned, wherein each grinding element is enclosed in a thermoplastic holder, which is in turn spring-mounted on the cleaning element.

2. Device according to claim 1, wherein the element comprises a so-called nylon scouring disk.

3. Device according to claim 1, wherein the element is designed with a brush surface.

4. Use of a cleaning element according to claim 1, wherein dry polishing is first performed using the cleaning element, following which wet cleaning is carried out using a conventional cleaning element.
